(19) United States
(12) Patent Application Publication
(10) Pub. No.: US 2020/0195590 A1
(43) Pub. Date: Jun. 18, 2020

(54) SYSTEM AND METHOD FOR GENERATING AND TRANSMITTING AUTOMATIC REPLY MESSAGES

(71) Applicant: Zipwhip, Inc., Seattle, WA (US)

(72) Inventors: John Lauer, Seattle, WA (US); Anthony Riemma, Seattle, WA (US); Carl Derline, Seattle, WA (US); James Lapic, Kirkland, WA (US); Alan Capps, Monroe, WA (US); Michael Smyers, Seattle, WA (US)

(21) Appl. No.: 16/224,538

(22) Filed: Dec. 18, 2018

(51) Int. Cl. H04L 12/58; H04W 4/14; G06F 17/27

(52) U.S. Cl. CPC H04L 51/02; G06F 17/2705; H04L 51/26; H04W 4/14

(57) ABSTRACT

A method and apparatus receive inputs corresponding to one or more trigger parameters at a graphical user interface. The one or more trigger parameters are then utilized to generate an event processor. The event processor then subscribes to a message receive channel, selects messages to provide an autoreply message based on the one or more trigger parameters, selects the autoreply message for the messages, and publishes the autoreply message. Each of the messages selected by the event processor and the autoreply message published are displayed on the graphical user interface.

### BACKGROUND

A business may interact with a customer utilizing a messaging user interface. Conventional message reply systems merely enable static replies to a customer message. Additionally, conventional systems may rely on a user who is interacting with a customer to copy and paste standard message replies, even when those replies are performed many times.

### BRIEF SUMMARY

The present system enables a user to determine dynamic parameters to automatically generate message replies to a customer. The system increases the efficiency of the user by enabling the user to perform fewer interactions with a user interface to reply to a customer message.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of a message processing system 100.

FIG. 2 illustrates an embodiment of an event autoreply method 200.

FIG. 3 illustrates an embodiment of an event processor setup method 300.

FIG. 4 illustrates an embodiment of a keyword event processor method 400.

FIG. 5 illustrates an embodiment of a time period event processor method 500.

FIG. 6 illustrates an embodiment of a token event processor method 600.

FIG. 7 illustrates an embodiment of a multiple trigger parameter method 700.

FIG. 8 illustrates an embodiment of a graphical user interface 800.

FIG. 9 illustrates an embodiment of a graphical user interface 900.

FIG. 10 is an example block diagram of a computing device 1000 that may incorporate embodiments of the present invention.

### DETAILED DESCRIPTION

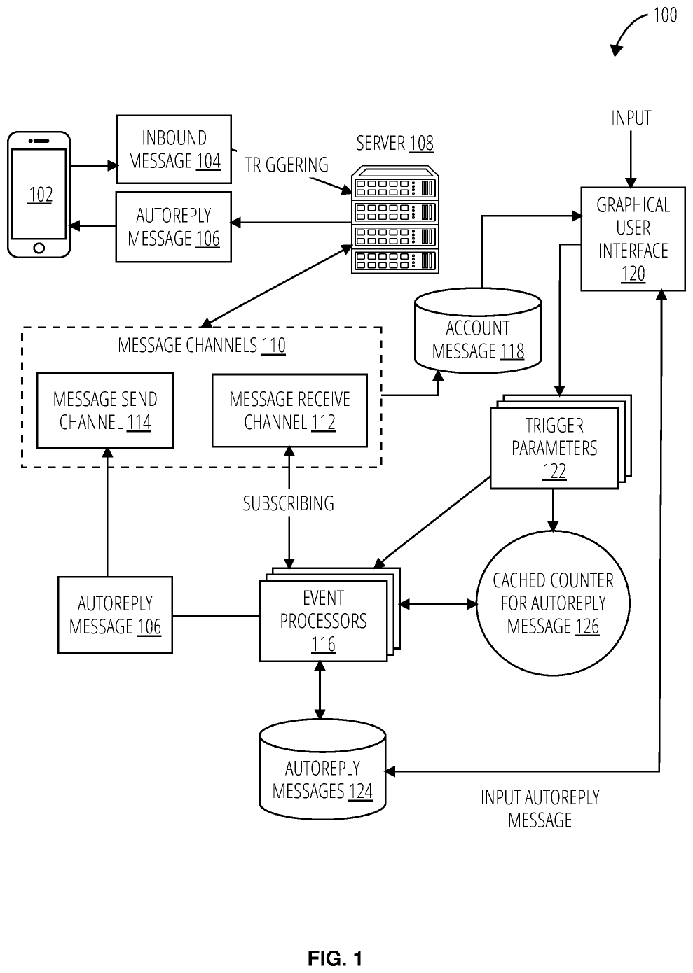

Referring to FIG. 1, a message processing system 100 comprises a device 102, an inbound message 104, an autoreply message 106, a server 108, message channels 110 (including a message receive channel 112 and a message send channel 114), event processors 116, an account message control memory structure 118, a graphical user interface 120, one or more trigger parameters 122, an autoreply message control memory structure 124, and a cached counter 126.

The device 102 sends and receive messages, such as the inbound message 104 and the autoreply message 106 from the server 108. The device 102 may include input devices, such as a keypad, touchscreen, audio receiver, etc. The device 102 may also include a display. The display may depict the inbound message 104 and the autoreply message 106. The inbound message 104 may be able to connect to a network to access the server 108. The network may include Short-Messaging Service (SMS) capability.

The inbound message 104 is sent from the device 102 to the server 108. The inbound message 104 may comprise alphanumeric text and be formatted, such as an SMS format. The inbound message 104 may comprise other symbols, such as emojis. The inbound message 104 is then received at the message receive channel 112 of the message channels 110.

The autoreply message 106 is selected by the event processors 116 from the autoreply message control memory structure 124. Each autoreply message 106 may be received from an input to the graphical user interface 120. The input may associate the autoreply message 106 with one or more of the event processors 116. The autoreply message 106 is sent to the message send channel 114 and sent from the server 108 to the device 102. The autoreply message 106 may comprise alphanumeric text and be formatted, such as an SMS format. The inbound autoreply message 106 may comprise other symbols, such as emojis.

The server 108 receives the inbound message 104 from the device 102 and sends the inbound message 104 to the message receive channel 112. The server 108 also receives the autoreply message 106 from the message send channel 114 and sends the autoreply message 106 to the device 102. The server 108 may format the autoreply message 106, such as with an SMS format.

The message channels 110 comprises the message receive channel 112 and the message send channel 114. The message receive channel 112 receives messages (e.g., the inbound message 104) from the server 108. The inbound message 104 may receive a message identifier. The message identifier may be unique. Each of the messages (or a copy of the message) is sent to the account message control memory structure 118 to be stored. The message receive channel 112 is subscribed to by the event processors 116. The message receive channel 112 subscribed to may be based on the account utilized to generate the event processors 116. The messages may be sent to the event processors 116 to determine whether those messages are to receive an autoreply message 106. The message send channel 114 receives the autoreply message 106 from the event processors 116. In some embodiments, the autoreply message 106 is received from the autoreply message control memory structure 124. The message receive channel 112 and the message send channel 114 utilized may be based on the account utilized to generate the event processors 116. The autoreply message 106 may receive a message ID. The message ID may be unique. The autoreply message 106 (or a copy of the autoreply message 106) is sent to the account message control memory structure 118 to be stored. The autoreply message 106 is then sent to the server 108 to be sent to the device 102.

The event processors 116 are generated from the one or more trigger parameters 122. Each account may have one or more event processors 116. Each of these event processors 116 may have different trigger parameters. Once generated, each of the event processors 116 may be de-activated in response to the graphical user interface 120 receiving an input to de-activate the event processor. That event processor may then be re-activated in response to the graphical user interface 120 receiving an input to re-activate the event processor.

The event processors 116 subscribe to a message receive channel 112. The event processors 116 may subscribe to multiple message receive channels 112. The event processors 116 selects messages from the message receive channel 112 to provide an autoreply message 106 based on the one or more trigger parameters 122. Each message may be received by the event processors 116, or a control signal may be sent to the message receive channel 112 to determine which of the messages in the message receive channel 112 are to receive an autoreply message 106. The event processors 116 then select the autoreply message 106 for the messages. The autoreply message 106 may be stored in the autoreply message control memory structure 124. The event processors 116 then publish the autoreply message 106 to a message send channel 114. The event processors 116 may further add a token to the cached counter 126. The token saves a state of the specific one of the event processors 116 to indicate that the autoreply message 106 has been processed by that event processor. The token may further include a timestamp. The timestamp may be added by the event processors 116, the cached counter 126, or some other component. The token then influences whether a message is to receive an autoreply message 106 or the selection of the autoreply message 106 by the one of the event processors 116 that added the token to the cached counter 126. The token may also influence other event processors 116. The token may influence the event processor for a pre-determined time period from the timestamp. The pre-determined time period may be determined by the event processor, the cached counter 126, or some other component, or the pre-determined time period may be received as an input to the graphical user interface 120. The pre-determined time period may then be included with the one or more trigger parameters 122 utilized to generate the event processors 116 or sent to the cached counter 126 associated with the event processor to which the pre-determined time period applies.

Each of the event processors 116 may be configured to perform additional functions based on the one or more trigger parameters 122 utilized to generate that event processor. For example, one of the event processors 116 may parse each of the messages into a set of words. The event processors 116 may then determine whether a keyword is included in the set of words. The keyword may be provided by the one or more trigger parameters 122. In some embodiments, exact matching may be utilized. In other embodiments, similar words or phrases may be utilized for the keyword or each of the words in the set of words. The event processors 116 then trigger selection of the autoreply message 106 based on the keyword (or similar words and phrases) being included in the set of words (or similar words and phrases). In another exemplary function, the event processors 116 may determine a timestamp associated with each of the messages. The timestamp may be added by the server 108, the message receive channel 112, or another component. The event processors 116 determine whether the timestamp is within a time period determined by the one or more trigger parameters 122. The event processors 116 then trigger selection of the autoreply message 106 based on the timestamp being within the time period.

The account message control memory structure 118 receives and stores the messages from the message receive channel 112 and the autoreply message 106 from the message send channel 114. The account message control memory structure 118 may then send the messages and the autoreply message 106 to the graphical user interface 120 to be displayed.

The graphical user interface 120 is an interface to receive inputs to select the one or more trigger parameters 122 to generate the event processors 116. The graphical user interface 120 displays the messages and the autoreply message 106. The graphical user interface 120 may display the messages received by the message receive channel 112 or a selection of those messages, such as those messages that receive an autoreply message 106. The graphical user interface 120 may also receive inputs to de-activate and re-activate the event processors 116. Further, the graphical user interface 120 may receive an input to store an autoreply message 106 in the autoreply message control memory structure 124, as well as associating that autoreply message 106 with at least one of the event processors 116. The graphical user interface 120 may receive a response from the autoreply message control memory structure 124 when an autoreply message 106 is updated as a result of an input to the graphical user interface 120. The response may cause the graphical user interface 120 to generate a new event processor with the same one or more trigger parameters but is associated with the updated autoreply message 106. The new event processor may have a different cached counter 126 and thus not be influence by previously received tokens. The graphical user interface 120 may also be configured to receive an update to the one or more trigger parameters 122 periodically. For example, the graphical user interface 120 may display a trigger parameter update interface about weekly.

A business may wish to utilize text messaging to interact with customers and require a means to integrate this messaging easily with the customer's Internet experience and the business' sales and customer service pipeline. The business may interact with a user interface, inputting a reply number and a contact message to configure a user interface (UI) generator to generate a user interface. The reply number may be a text-enabled number which may be linked to a mobile device or may be linked to a non-mobile number which is provisioned for SMS communication. The UI generator may generate a first structured graphical user interface (GUI). The first structured GUI may be provided to the business user, preconfigured to route contact requests to the business user by generating or triggering the appropriate response depending on a customer's experience. The first structured GUI may be automatically generated and linked on a business user's website or mobile app, or may be provided in markup, for example HTML or XML.

The first structured GUI may also be implemented as machine logic, for example, Javascript, which the user may then integrate manually into their website or application as a non-transitory machine logic configuration for operating a computer processor. This first user interface when instantiated by the processor may comprise, for example a link or button, and a text interface. The button or other visual trigger may communicate to the customer the need to perform a triggering action, and may be operable for that purpose. The first structured GUI may also provide instructions and the functionality to allow the customer to add or modify a message to the business. A customer may navigate to the first user interface with the auto-generated button on it. The user then clicks on the button and the format selector, selecting the correct format for the user's experience based on whether that user is using a mobile device or a non-mobile device.

The format selector may use, for example, user agent information to identify the device being used. If the user is using a mobile device, the format selector may select a native app trigger to send to the mobile device to trigger the device to load its native messaging application. The native messaging application may then be populated with the contact message, which may then be sent by the user through their carrier's SMS server. In the event that the user is utilizing a non-mobile device, the format selector may configure the UI generator with the response format to generate a second structured GUI. The second structured GUI may then be pre-populated with the contact number and the contact message. Because the non-mobile device is likely not connected to a mobile carrier network, the message may then be sent to a server over a standard internet connection, for example, Ethernet. Once the message reaches the server, the message may then be transferred to an SMS number and transmitted to the reply number via a separate “temporary” number. The temporary number may be an account or telephone number which has been provisioned to transmit internet to SMS traffic. The reply number may be routed back to an SMS provisioned non-mobile device or a mobile device. The business account may then be utilized to interact with the customer via this connection.

The business account may receive replies on a third structured GUI, which may further allow the business to track and integrate communications with the business' customer flow. A UI generator is configured with a reply number and a contact message to generate a first structured GUI, and a contact request is received on the first structured GUI. The contact request is parsed into user agent information, a user message, and a user number with a request analyzer. A format selector is operated with the user agent information to select a response format. The response format may be a native app trigger if the user agent information indicates a mobile device. The response format may configure the UI generator to generate a second structured GUI if the user agent information indicates a non-mobile browser. A response is pre-populated with the user number and the contact message, and transmitted with the response to the reply number via an SMS server.

The one or more trigger parameters 122 are selected by inputs to the graphical user interface 120. The one or more trigger parameters 122 are then utilized to generate one or more event processors 116. The one or more trigger parameters 122 may include time periods, keywords, customer accounts sending the inbound message 104, user accounts associated with the event processors 116, etc [[inventors: please broaden, if applicable]]. The one or more trigger parameters 122 may be related by logical operators (such as Boolean logic). Exemplary one or more trigger parameters 122 utilized to generate one of the event processors 116 include the time period from 7:00 pm to 7:00 am and the keyword “help”. These one or more trigger parameters 122 are then related by the operator “AND”. Thus, an inbound message 104 with a timestamp of 12:48 am with the content of “Can you help me with my service?” may be selected by the one of the event processors 116 generated by the exemplary one or more trigger parameters 122. The one or more trigger parameters 122 may also be utilized to generate event processors 116 for account level events, such as initiation of the account, blocking a device 102 from sending an inbound message 104 to the message receive channel 112, and stopping the event processors 116 from generating an autoreply message 106 for a customer account. For example, each customer account may receive an autoreply message 106 in response to the first inbound message 104 received by the message receive channel 112. The message processing system 100 may include a message counter to determine the number of messages received from each customer account. In another example, an autoreply message 106 may be associated with a customer account. The autoreply message 106, when sent to a device 102 associated with that customer account by the server 108, configures the server 108 to not send further inbound message 104 to the message receive channel 112. In yet another example, each of the event processors 116 may include a keyword trigger parameter, such as “stop”. An inbound message 104 to a message receive channel 112 may then de-activate the associated event processors 116.

The autoreply message control memory structure 124 stores each autoreply message 106. A different autoreply message control memory structure 124 may be associated with each user account. The autoreply messages 106 are retrieved from the autoreply message control memory structure 124 by the event processors 116, which are then sent to the event processor retrieving the autoreply message 106 or to the message send channel 114. The autoreply message control memory structure 124 may also send a control signal to a graphical user interface 120 (or another component) in response to receiving an update to an autoreply message 106. The control signal may result in the generation of a new event processor.

The cached counter 126 stores the state of each of the event processors 116. Each of the event processors 116 may have a cached counter 126. The state may be stored by receiving a token, which may have an associated timestamp. The timestamp is then utilized to influence the operation of the event processors 116 for a pre-determined time period. The cached counter 126 may inhibit one of the event processors 116 from sending an autoreply message 106 if the inbound message 104 is within the pre-determined time period of the timestamp. For example, a token was sent to the cached counter 126 with a timestamp of 5:47 pm and a pre-determined time period of two (2) hours. The event processor then receives a second inbound message 104 at 6:02 pm. The event processor may have one or more trigger parameters 122 associated with sending an autoreply message 106. However, the token in the cached counter 126 inhibits the event processor from sending the autoreply message 106.

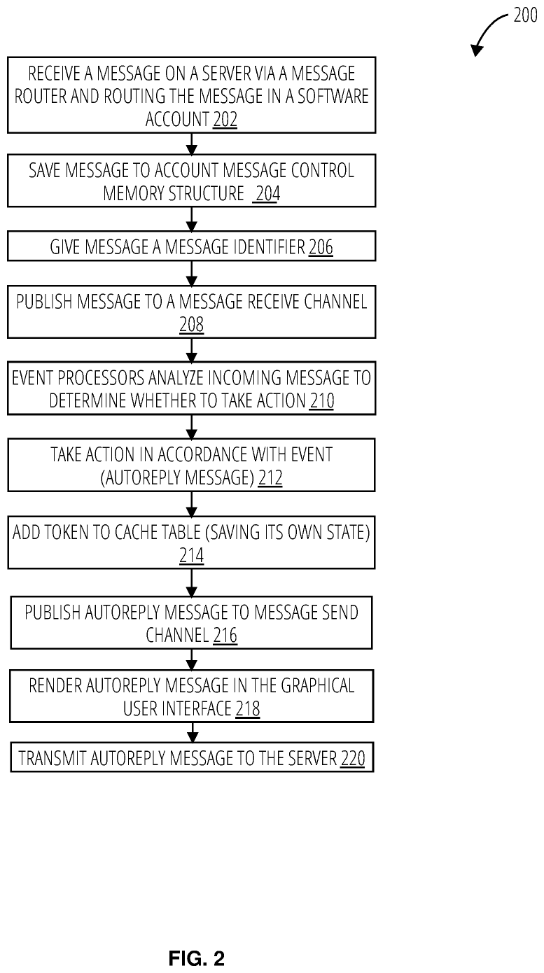

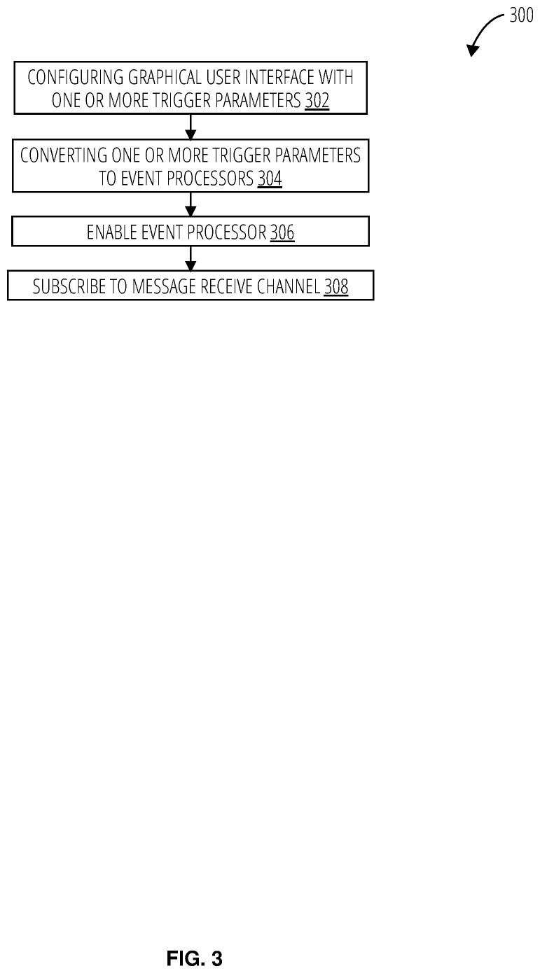

The message processing system 100 may be operated in accordance with the processes depicted in FIG. 2 and FIG. 3.

Referring to FIG. 2, an event autoreply method 200 receives a message on a server via a messenger router and routing the message into the software account (block 202). The message is saved to the account message control memory structure (block 204). The message is given a message identifier, which may be unique, (block 206) and published to a message receive channel (block 208). Each event processor subscribed to the message receive channel receives a message receipt event and analyzes the incoming message to determine whether the event processor is to take action (block 210). The event processor may utilize one or more trigger parameters to determine whether to take action. The action the event processor takes may be influenced by the presence of a token in the cached counter and the pre-determined time period associated with that cached counter. Each event processor then takes action in accordance with the event (block 212). The event processor may select an autoreply message from an autoreply message control memory structure. The event processor adds a token to the cached counter (block 214). The cached counter may be a table, and the event processor may save its state to indicate that its event (autoreply message) has been processed. The autoreply message is published to the message send channel (block 216). The autoreply message is rendered on a graphical user interface (block 218). The autoreply message may also be stored in the account message control memory structure and assigned a message identifier, which may be unique. The autoreply message may then be sent to a server (block 220). The server may be configured to send SMS messages, and the autoreply message may be sent to the device that sent the incoming message or another associated device.

Referring to FIG. 3, an event processor setup method 300 configures a graphical user interface with one or more trigger parameters (block 302). The graphical user interface may receive an input associated with each of the one or more trigger parameters to select the trigger parameter. The selected one or more trigger parameters are converted into an event processor (block 304). An application program interface request may be made with the trigger parameters to generate the event processor. The event processor is then enabled (block 306). The event processor may be associated with a message send channel, an autoreply message control memory structure, a cached counter, and other components. The event processor is subscribed to a message receive channel for the user account (block 308). The event processor may be subscribed to multiple message receive channels.

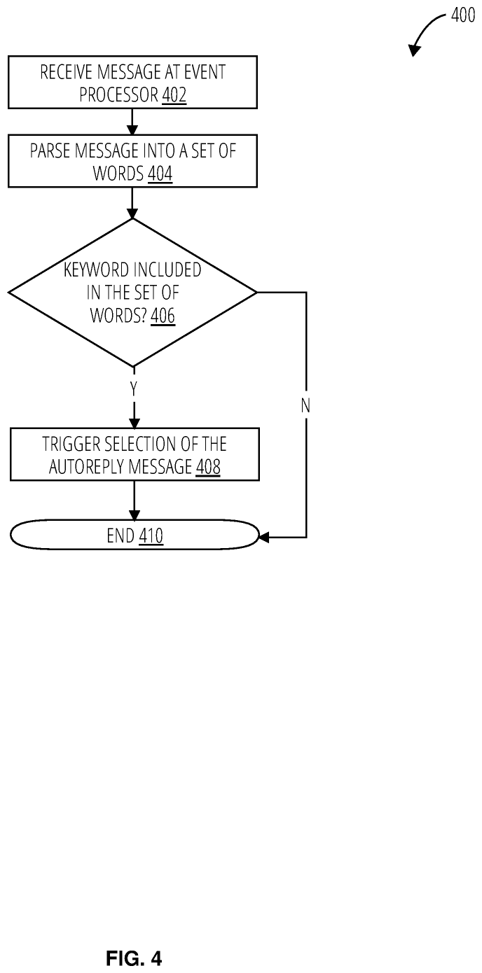

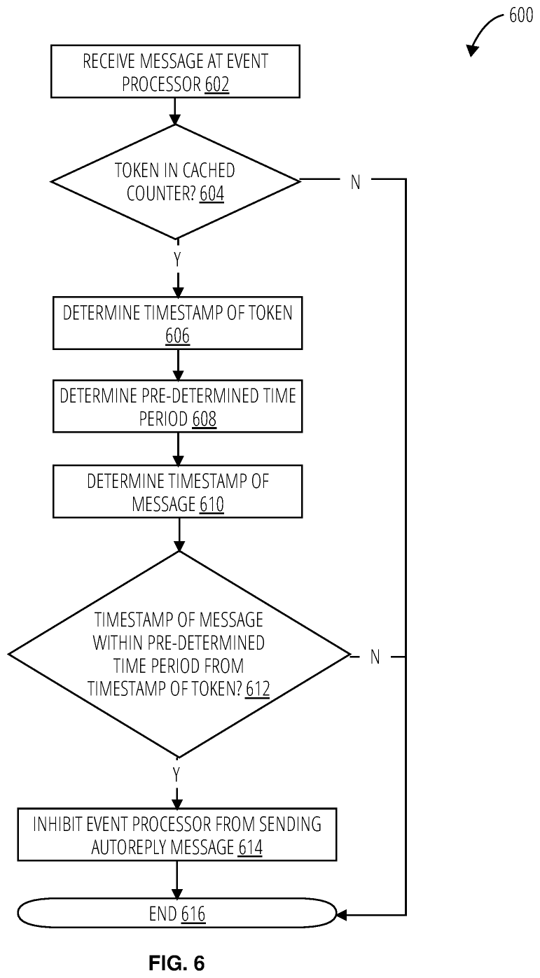

Referring to FIG. 4, a keyword event processor method 400 receives a message at event processor (block 402). The message is parsed into a set of words (block 404). The keyword event processor method 400 determines whether the keyword is included in the set of words (decision block 406). The keyword event processor method 400 may convert each word in the set of words and the keyword into similar words and phrases. If so the selection of the autoreply message is triggered (block 408). Once the autoreply message is triggered or if the keyword is not included in the set of words, the keyword event processor method 400 ends (done block 410). In some embodiments, the token event processor method 600 depicted in FIG. 6 is performed after triggering the selection of an autoreply message.

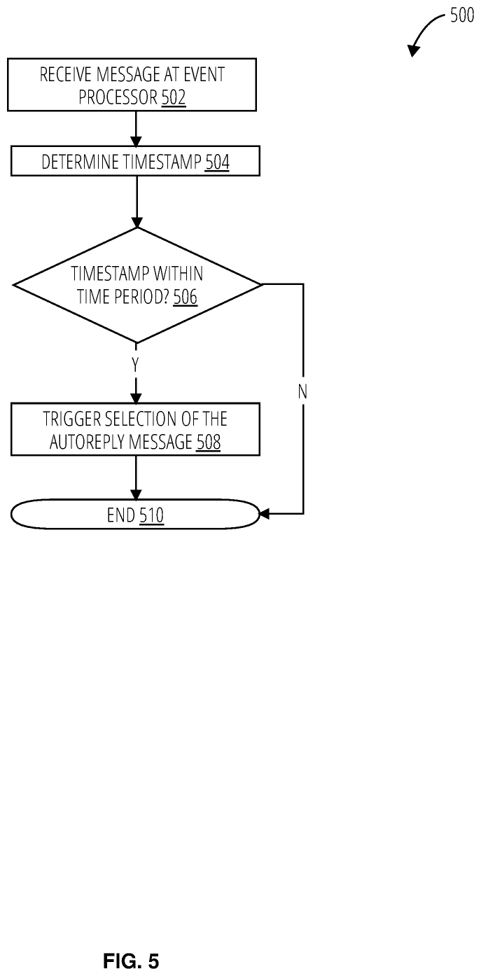

Referring to FIG. 5, a time period event processor method 500 receives a message at event processor (block 502). A timestamp for the message is then determined (block 504). The time period event processor method 500 then determine whether the timestamp is within a time period (decision block 506). The time period is determined by the trigger parameter. If so, the selection of the autoreply message is triggered (block 508). Once the autoreply message is triggered or if the timestamp is not within the time period, the time period event processor method 500 ends (done block 510). In an alternate embodiment, the time period event processor method 500 determines whether the timestamp is not within the time period. Such a determination triggers the selection of the autoreply message. In some embodiments, the token event processor method 600 depicted in FIG. 6 is performed after triggering the selection of an autoreply message.

Referring to FIG. 6, a message is received at event processor (block 602). The token event processor method 600 determines whether a token is in the cached counter (decision block 604). If so, the timestamp of the token is determined (block 606), the pre-determined time period is determined (block 608), and the timestamp of the message is determined (block 610). The token event processor method 600 then determines whether the timestamp of the message is within the pre-determined time period from the timestamp of token (decision block 612). If so, the event processor is inhibited from sending an autoreply message (block 614). After the event processor is inhibited, if there is no token in the cached counter, or if the timestamp of the message is not within the pre-determined time period from the timestamp of token, the token event processor method 600 ends (done block 616).

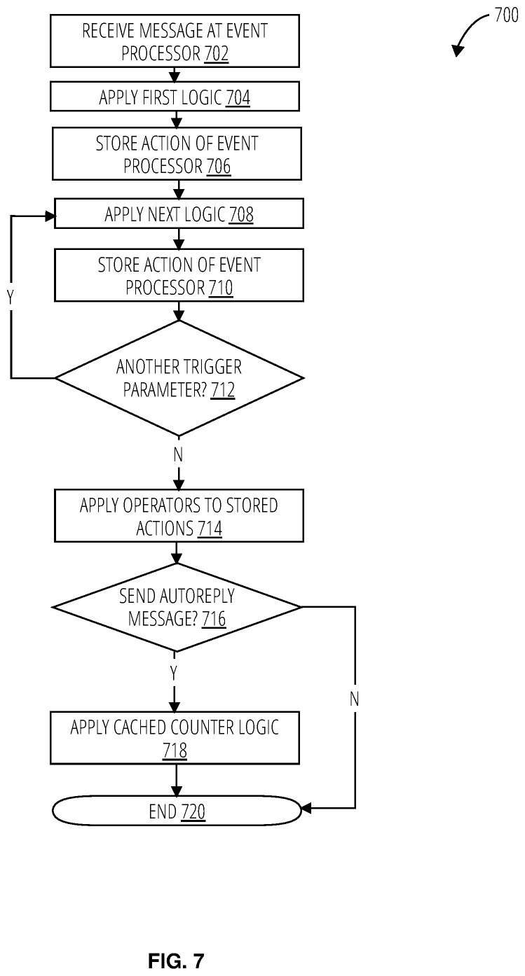

Referring to FIG. 7, a multiple trigger parameter method 700 receives a message at an event processor (block 702). The first logic is applied (block 704). The first logic may be the keyword event processor method 400, the time period event processor method 500, or another logic associated with an event processor. The action determined by the event processor for the first logic is then stored (block 706). Exemplary actions include sending an autoreply message or not sending an autoreply message. A next logic is then applied (block 708). The next logic may be the keyword event processor method 400, the time period event processor method 500, or another logic associated with an event processor. The same logic may be applied to the message, as for example there may be multiple keyword trigger parameters for an event processor. The action determined by the event processor for the next logic is then stored (block 710). The multiple trigger parameter method 700 then determines whether there is another trigger parameter for the event processor (decision block 712). If so, the multiple trigger parameter method 700 repeats the block 708, the block 710, and the decision block 712 until there are no more trigger parameters for the event processor. Once there are no additional trigger parameters, operators are applied to the stored actions (block 714). The operators may be logical Boolean operators, such as “AND”, “OR”, “NOT”, “NOR”, etc. The multiple trigger parameter method 700 determines whether to send the autoreply message based on the result of the operators being applied to the stored results (decision block 716). For example, an event processor may be a keyword, “NOT ‘hello’”, a time period, “5:00 pm to 7:45 am”, and the Boolean operator, “AND”. The message may be “Please help me” and the timestamp may be 8:43 pm. The action from the keyword logic is to send the autoreply message. The action from the time period logic is to send the autoreply message. Applying the “AND” operator results in an action to send an autoreply message. The cached counter logic is then applied (block 718). This process may be performed in accordance with the process depicted in FIG. 6. The multiple trigger parameter method 700 then ends (done block 720).

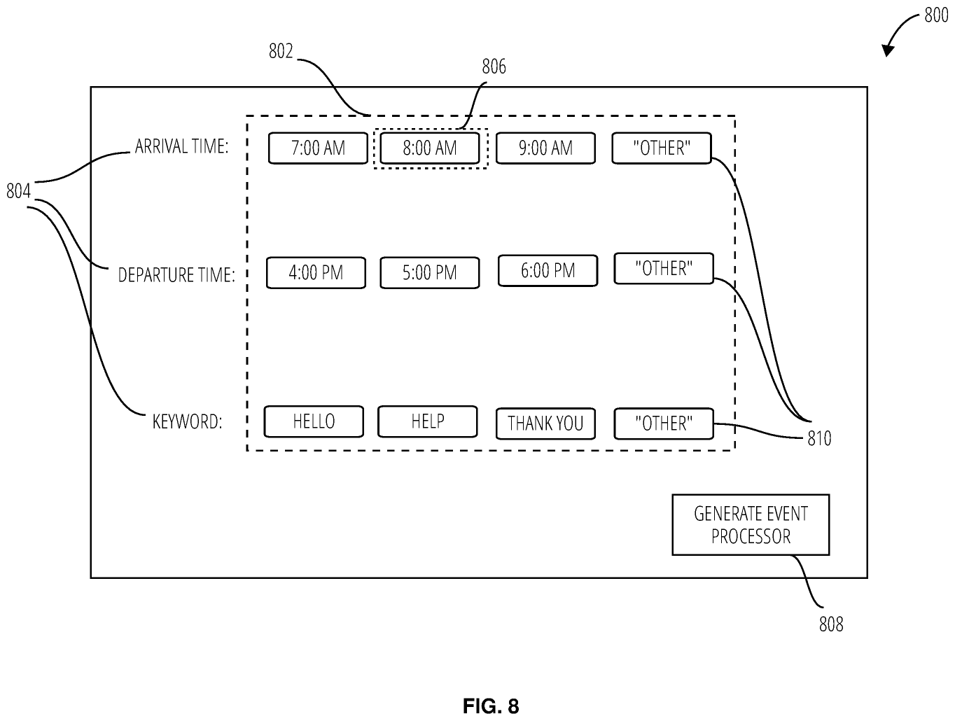

Referring to FIG. 8, a graphical user interface 800 comprises trigger parameters 802, trigger parameter descriptors 804, a trigger parameter selection indicator 806, an input selector 810, and an event processor generator 808.

The trigger parameters 802 are displayed on the graphical user interface 800 and are configured to receive an input, such as from a mechanical device, a touchscreen interface, an audio receiver, etc. The trigger parameters 802 may be presented on the graphical user interface 800 by categories of the trigger parameters 802. The trigger parameter descriptors 804 may describe the general category of each of the trigger parameters 802. The trigger parameters 802 displayed may be prioritized based on utilization by the user account, other user accounts, a combination thereof, or by other factors. The input may result in the selected trigger parameters 802 having a trigger parameter selection indicator 806. The trigger parameter selection indicator 806 may bold the text of the selected trigger parameters 802, highlight the selected trigger parameters 802, or otherwise indicate that the trigger parameters 802 have been selected by an input. Those trigger parameters 802 selected may then be converted into an event processor in response to an input being received at the event processor generator 808. An input at the event processor generator 808 may also alter the graphical user interface 800 to receive relations between the selected trigger parameters 802, such as Boolean logical operators.

The input selector 810 may alter the graphical user interface 800 to receive an input for a trigger parameter. The graphical user interface 800 may be altered to display a text input. The text input may receive text corresponding to a trigger parameter value. For example, the text input may be 8:30 am for the arrival time. Once the trigger parameter value has been received, the graphical user interface 800 may be re-configured to display the previous screen with the new trigger parameter value as one of the trigger parameters 802 in place of the input selector 810. The new one of the trigger parameters 802 may be selected and indicated as such by a trigger parameter selection indicator 806.

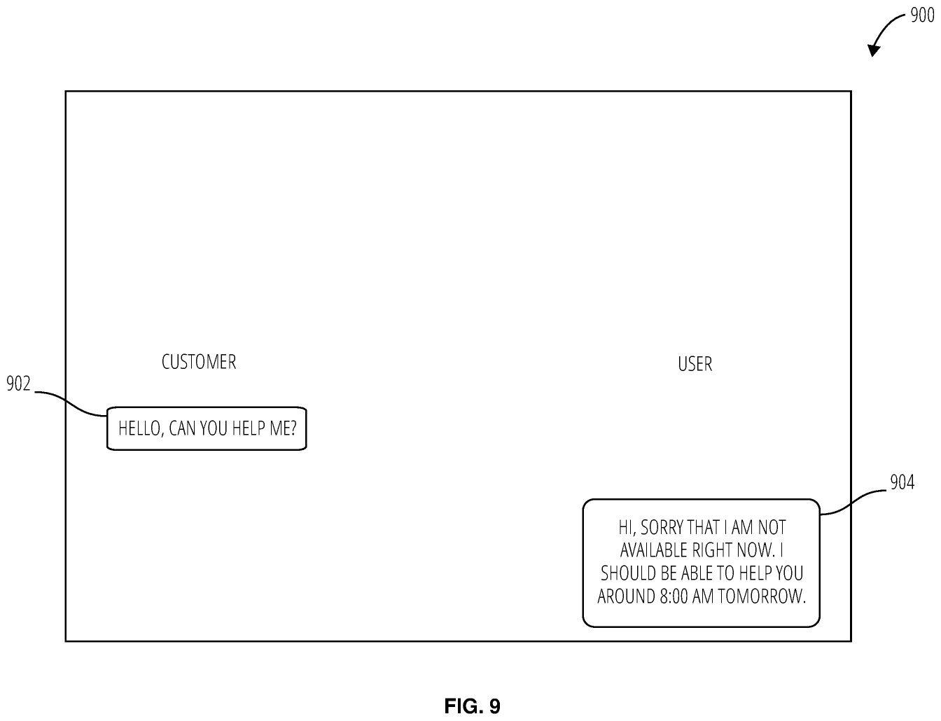

Referring to FIG. 9, a graphical user interface 900 comprises an incoming message 902 and an autoreply message 904.

The graphical user interface 900 may orient the incoming message 902 and the autoreply message 904 such that each has its own column of the graphical user interface 900. Each individual message may be placed within that column according to the time that the message was received at the graphical user interface 900, and further messages may alter the position of the incoming message 902 and the autoreply message 904.

The incoming message 902 was received at a message receive channel and sent to the graphical user interface 900 for display. An event processor then analyzed the incoming message 902 and determine that an autoreply message was to be sent in response. The event processor selected the autoreply message 904. The autoreply message 904 was sent to a message send channel where it was further sent to the graphical user interface 900 for display. Both the incoming message 902 and the autoreply message 904 may be stored in an account message control memory structure.

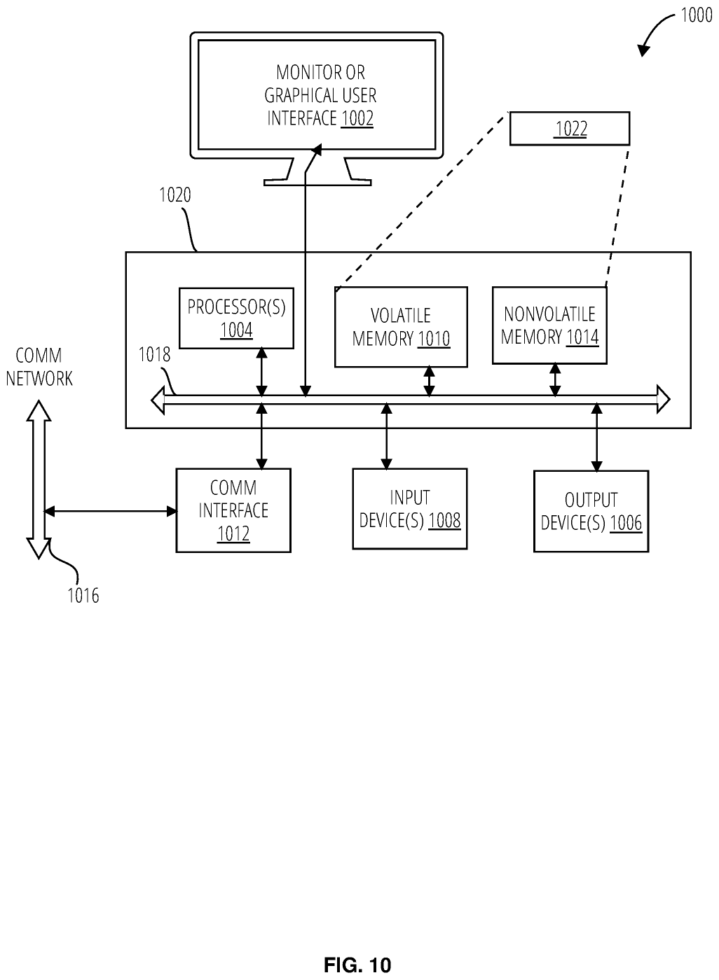

FIG. 10 is an example block diagram of a computing device 1000 that may incorporate embodiments of the present invention. FIG. 10 is merely illustrative of a machine system to carry out aspects of the technical processes described herein and does not limit the scope of the claims. One of ordinary skill in the art would recognize other variations, modifications, and alternatives. In one embodiment, the computing device 1000 typically includes a monitor or graphical user interface 1002, a data processing system 1020, a communication network interface 1012, input device(s) 1008, output device(s) 1006, and the like.

As depicted in FIG. 10, the data processing system 1020 may include one or more processor(s) 1004 that communicate with a number of peripheral devices via a bus subsystem 1018. These peripheral devices may include input device(s) 1008, output device(s) 1006, communication network interface 1012, and a storage subsystem, such as a volatile memory 1010 and a nonvolatile memory 1014.

The volatile memory 1010 and/or the nonvolatile memory 1014 may store computer-executable instructions and thus forming logic 1022 that when applied to and executed by the processor(s) 1004 implement embodiments of the processes disclosed herein.

The input device(s) 1008 include devices and mechanisms for inputting information to the data processing system 1020. These may include a keyboard, a keypad, a touch screen incorporated into the monitor or graphical user interface 1002, audio input devices such as voice recognition systems, microphones, and other types of input devices. In various embodiments, the input device(s) 1008 may be embodied as a computer mouse, a trackball, a track pad, a joystick, wireless remote, drawing tablet, voice command system, eye tracking system, and the like. The input device(s) 1008 typically allow a user to select objects, icons, control areas, text and the like that appear on the monitor or graphical user interface 1002 via a command such as a click of a button or the like.

The output device(s) 1006 include devices and mechanisms for outputting information from the data processing system 1020. These may include the monitor or graphical user interface 1002, speakers, printers, infrared LEDs, and so on as well understood in the art.

The communication network interface 1012 provides an interface to communication networks (e.g., communication network 1016) and devices external to the data processing system 1020. The communication network interface 1012 may serve as an interface for receiving data from and transmitting data to other systems. Embodiments of the communication network interface 1012 may include an Ethernet interface, a modem (telephone, satellite, cable, ISDN), (asynchronous) digital subscriber line (DSL), FireWire, USB, a wireless communication interface such as BlueTooth or WiFi, a near field communication wireless interface, a cellular interface, and the like.

The communication network interface 1012 may be coupled to the communication network 1016 via an antenna, a cable, or the like. In some embodiments, the communication network interface 1012 may be physically integrated on a circuit board of the data processing system 1020, or in some cases may be implemented in software or firmware, such as “soft modems”, or the like.

The computing device 1000 may include logic that enables communications over a network using protocols such as HTTP, TCP/IP, RTP/RTSP, IPX, UDP and the like.

The volatile memory 1010 and the nonvolatile memory 1014 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 1010 and the nonvolatile memory 1014 may be configured to store the basic programming and data constructs that provide the functionality of the disclosed processes and other embodiments thereof that fall within the scope of the present invention.

Logic 1022 that implements embodiments of the present invention may be stored in the volatile memory 1010 and/or the nonvolatile memory 1014. Said logic 1022 may be read from the volatile memory 1010 and/or nonvolatile memory 1014 and executed by the processor(s) 1004. The volatile memory 1010 and the nonvolatile memory 1014 may also provide a repository for storing data used by the logic 1022.

The volatile memory 1010 and the nonvolatile memory 1014 may include a number of memories including a main random access memory (RAM) for storage of instructions and data during program execution and a read only memory (ROM) in which read-only non-transitory instructions are stored. The volatile memory 1010 and the nonvolatile memory 1014 may include a file storage subsystem providing persistent (non-volatile) storage for program and data files. The volatile memory 1010 and the nonvolatile memory 1014 may include removable storage systems, such as removable flash memory.

The bus subsystem 1018 provides a mechanism for enabling the various components and subsystems of data processing system 1020 communicate with each other as intended. Although the communication network interface 1012 is depicted schematically as a single bus, some embodiments of the bus subsystem 1018 may utilize multiple distinct busses.

It will be readily apparent to one of ordinary skill in the art that the computing device 1000 may be a device such as a smartphone, a desktop computer, a laptop computer, a rack-mounted computer system, a computer server, or a tablet computer device. As commonly known in the art, the computing device 1000 may be implemented as a collection of multiple networked computing devices. Further, the computing device 1000 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

“Circuitry” refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” refers to software logic embodied as processor-executable instructions stored in read-only memories or media.

“Hardware” refers to logic embodied as analog or digital circuitry.

“Logic” refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

The disclosed systems and methods may be implemented using various combinations of logic distributed across one or more devices, depending on the requirements of the implementation.

“Software” refers to logic implemented as processor-executable instructions in a machine memory (e.g. read/write volatile or nonvolatile memory or media).

“Message” refers to an electronic communication between two accounts (or numbers), such as via a SMS or other messaging service.

“SMS server” refers to a computer or computer program that manages access to a centralized resource or service in a network to organize bilateral exchange with subscribers of GSM short text messages.

“Text message” refers to electronic messages, typically comprising alphabetic and numeric characters, formatted to be transmitted by a SMS server.

“Text” refers to alphabetic and numeric characters.

“Server” refers to a computer or computer program that manages access to a centralized resource or service in a network.

“Graphical user interface” refers to a visual way of interacting with a computer using items such as windows, icons, and menus.

“Keyword” refers to a set of text inputs.

“Message channel” refers to a unidirectional communications link between two systems.

“Timestamp” refers to a digital record of the time of occurrence of a particular event.

“Token” refers to an object (in software or in hardware) which represents the ability or inability to perform some operation.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

1. A method comprising:
receiving an input corresponding to one or more trigger parameters at a graphical user interface;
generating an event processor from the one or more trigger parameters to:
subscribe to a message receive channel, wherein the message receive channel comprises messages;
select at least one message from the message receive channel to provide an autoreply message based on the one or more trigger parameters;
select the autoreply message for the at least one message from an autoreply message control memory structure;
the event processor adding a token to a cached counter, the token saving a state of the event processor to indicate that the autoreply message has been processed;
the token associated with a timestamp, the token influencing selection of the autoreply message by the event processor for a pre-determined time period from the timestamp; and
publish the autoreply message to a message send channel;
configuring the graphical user interface to display each of the messages selected from the message receive channel and the published autoreply message; and
configuring the graphical user interface to receive a second input to de-activate the event processor.

2. The method of claim 1, wherein the one or more trigger parameters include a keyword, the event processor further configured to:
parse each of the messages into a set of words;
determine whether the keyword is included in the set of words; and
trigger selection of the autoreply message based on the keyword being included in the set of words.

3. The method of claim 1, wherein the one or more trigger parameters include a time period, the event processor configured to:
determine a timestamp associated with each of the messages;
determine whether the timestamp is within the time period; and
trigger selection of the autoreply message based on the timestamp being within the time period.

4. The method of claim 1, further comprising:
storing each of the messages selected from the message receive channel and the autoreply message published in an account message control memory structure; and
associating each of the messages selected from the message receive channel and the autoreply message published with a message identifier.

5. The method of claim 1, wherein the graphical user interface is periodically configured to receive a modification input, the modification input modifying the one or more trigger parameters.

6. (canceled)

7. The method of claim 1, wherein the graphical user interface is configured to receive the autoreply message corresponding to the one or more trigger parameters, further comprising storing the autoreply message in the autoreply message control memory structure.

8. The method of claim 7, further comprising generating a second event processor in response to storing an updated autoreply message, the updated autoreply message updating one of the autoreply messages in the autoreply message control memory structure.

9. A computing apparatus, the computing apparatus comprising:
a processor; and
a memory storing instructions that, when executed by the processor, configure the apparatus to:
receive an input corresponding to one or more trigger parameters at a graphical user interface;
generate an event processor from the one or more trigger parameters to:
subscribe to a message receive channel, wherein the message receive channel comprises messages;
select at least one message from the message receive channel to provide an autoreply message based on the one or more trigger parameters;
select the autoreply message for the at least one message from an autoreply message control memory structure;
the event processor adding a token to a cached counter, the token saving a state of the event processor to indicate that the autoreply message has been processed;
the token associated with a timestamp, the token influencing selection of the autoreply message by the event processor for a pre-determined time period from the timestamp; and
publish the autoreply message to a message send channel;
configure the graphical user interface to display each of the messages selected from the message receive channel and the autoreply message published; and
configure the graphical user interface to receive a second input to de-activate the event processor.

10. The computing apparatus of claim 9, wherein the one or more trigger parameters include a keyword, the event processor further configured to:
parse each of the messages into a set of words;
determine whether the keyword is included in the set of words; and
trigger selection of the autoreply message based on the keyword being included in the set of words.

11. The computing apparatus of claim 9, wherein the one or more trigger parameters include a time period, the event processor configured to:
determine a timestamp associated with each of the messages;
determine whether the timestamp is within the time period; and
trigger selection of the autoreply message based on the timestamp being within the time period.

12. The computing apparatus of claim 9, wherein the instructions further configure the apparatus to:
store each of the messages selected from the message receive channel and the autoreply message published in an account message control memory structure; and
associate each of the messages selected from the message receive channel and the autoreply message published with a message identifier.

13. The computing apparatus of claim 9, wherein the graphical user interface is periodically configured to receive a modification input, the modification input modifying the one or more trigger parameters.

14. (canceled)

15. The computing apparatus of claim 9, wherein the graphical user interface is configured to receive the autoreply message corresponding to the one or more trigger parameters, wherein the instructions further configure the apparatus to store the autoreply message in the autoreply message control memory structure.

16. The computing apparatus of claim 15, wherein the instructions further configure the apparatus to generate a second event processor in response to storing an updated autoreply message, the updated autoreply message updating one of the autoreply messages in the autoreply message control memory structure.

17. The method of claim 1, wherein the graphical user interface is configured to receive a third input to re-activate the event processor.

18. The method of claim 1, wherein the graphical user interface is configured to periodically display a trigger parameter update interface.

19. The computing apparatus of claim 9, wherein the graphical user interface is configured to receive a third input to re-activate the event processor.

20. The computing apparatus of claim 9, wherein the graphical user interface is configured to periodically display a trigger parameter update interface.
